(19) United States
(12) Patent Application Publication
(10) Pub. No.: US 2024/0310506 A1
(43) Pub. Date: Sep. 19, 2024

(54) RADAR SYSTEM AND METHOD FOR SCANNING OBJECTS

(71) Applicant: TRON FUTURE TECH INC., HSINCHU CITY (TW)

(72) Inventors: YEN-MING HUANG, HSINCHU CITY (TW); CHENG-YUNG KE, HSINCHU CITY (TW); PAO MING LU, HSINCHU CITY (TW); BOR-CHING SU, HSINCHU CITY (TW); YU-JIU WANG, HSINCHU CITY (TW)

(21) Appl. No.: 18/607,000

(22) Filed: Mar. 15, 2024

Related U.S. Application Data
(60) Provisional application No. 63/490,765, filed on Mar. 16, 2023.

(51) Int. Cl. G01S 13/72; G01S 13/02; G01S 13/10

(52) U.S. Cl. CPC G01S 13/72; G01S 13/10; G01S 2013/0254

(57) ABSTRACT

The present application discloses a radar system. The radar system includes a first subarray, a second subarray, and a third subarray. Antennas in the first subarray and the second subarray are disposed along a first axis, and antennas in the third subarray are disposed along a second axis. When scanning a radar coverage of the radar system, the radar system utilizes the first subarray and the second subarray as RF signal transceivers and utilizes the third subarray as a RF signal receiver to scan a first detection distance range according to first signal parameters and scan a second detection distance range according to second signal parameters. A maximum distance measured from the radar system to each detectable location in the first detection distance range is less than or equal to a minimum distance measured from the radar system to each detectable location in the second detection distance range.

### CROSS REFERENCE

This application claims the benefit of prior-filed U.S. provisional application No. 63/490,765, filed on Mar. 16, 2023, which is incorporated by reference in its entirety.

### TECHNICAL FIELD

The present disclosure relates to a radar system, and more particularly, to an active electronically scanned array (AESA) radar system.

### DISCUSSION OF THE BACKGROUND

Phase array radar, also known as Active Electronically Scanned Array (AESA), is able to emit radio frequency waves in different directions using beamforming techniques without moving the antenna components. However, since the AESAs typically require large size, great power, and high cost, the AESAs are often used in the military application and are difficult to be applied in commercialized products for civilian markets.

In addition, targeting objects to be detected in the civilian applications, such as drones, have smaller radar cross sections (RCSs), slower speeds, and arbitrary trajectories, which differs from the characteristics of the objects to be detected in the military applications, such as missiles, fighter jets, or ships. Therefore, how to use AESA technology to achieve a radar detection system that can meet the commercial needs has become an issue to solve.

This Discussion of the Background section is provided for background information only. The statements in this Discussion of the Background are not an admission that the subject matter disclosed in this section constitutes prior art to the present disclosure, and no part of this Discussion of the Background section may be used as an admission that any part of this application, including this Discussion of the Background section, constitutes prior art to the present disclosure.

### SUMMARY

One aspect of the present disclosure provides a radar system. The radar system includes a first subarray, a second subarray, and a third subarray. The first subarray includes a plurality of first antennas disposed along a first axis. The second subarray includes a plurality of second antennas disposed along the first axis. The third subarray includes a plurality of third antennas disposed along a second axis orthogonal to the first axis. In a first scanning mode for scanning a radar coverage of the radar system, the radar system utilizes the first subarray and the second subarray as radio frequency (RF) signal transceivers and utilizes the third subarray as a RF signal receiver to scan a first detection distance range according to a plurality of first signal parameters, and scan a second detection distance range according to a plurality of second signal parameters. A maximum distance measured from the radar system to each detectable location in the first detection distance range is less than or equal to a minimum distance measured from the radar system to each detectable location in the second detection distance range.

Another aspect of the present disclosure provides a method for scanning objects. The method includes arranging a first subarray comprising a plurality of first antennas to dispose the plurality of first antennas along a first axis, arranging a second subarray comprising a plurality of second antennas to dispose the plurality of second antennas along the first axis, and arranging a third subarray comprising a plurality of third antennas to dispose the plurality of third antennas along a second axis orthogonal to the first axis. The method further includes in a first scanning mode for scanning a radar coverage of the radar system, utilizing the first subarray and the second subarray as radio frequency (RF) signal transceivers and utilizing the third subarray as a RF signal receiver to scan a first detection distance range according to a plurality of first signal parameters and scan a second detection distance range according to a plurality of second signal parameters. A maximum distance measured from the radar system to each detectable location in the first detection distance range is less than or equal to a minimum distance measured from the radar system to each detectable location in the second detection distance range.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures.

FIG. 1 shows a radar system according to some embodiments of the present disclosure.

FIG. 2 shows a method for scanning objects with the radar system in FIG. 1 according to some embodiments of the present disclosure.

FIG. 3 shows functional blocks of the radar system in FIG. 1 according to some embodiments of the present disclosure.

FIG. 4 shows the RF beams that are steered to different directions in different periods of time according to some embodiments of the present disclosure.

FIG. 5 shows a scanning scheme of the radar system in FIG. 1 under a first scanning mode according to some embodiments of the present disclosure.

FIG. 6 shows steps of the method for scanning objects in a one-round scan interval under the first scanning mode according to some embodiments of the present disclosure.

FIG. 7 shows a scanning scheme of the radar system in FIG. 1 under the first scanning mode with a shielding sector according to some embodiments of the present disclosure.

FIG. 8 shows a timing diagram of RF signals transmitted by a transmitter TX and RF signals received by a receiver RX of the radar system in FIG. 1 when scanning one azimuth angle in one detection distance range according to some embodiments of the present disclosure.

FIG. 9 shows a scanning scheme of the radar system in FIG. 1 under the second scanning mode according to some embodiments of the present disclosure.

FIG. 10 shows a scanning scheme of the radar system in FIG. 1 under the third scanning mode according to some embodiments of the present disclosure.

### DETAILED DESCRIPTION

The following description of the disclosure accompanies drawings, which are incorporated in and constitute a part of this specification, and which illustrate embodiments of the disclosure, but the disclosure is not limited to the embodiments. In addition, the following embodiments can be properly integrated to complete another embodiment.

References to “one embodiment,” “an embodiment,” “exemplary embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

In order to make the present disclosure completely comprehensible, detailed steps and structures are provided in the following description. Obviously, implementation of the present disclosure does not limit special details known by persons skilled in the art. In addition, known structures and steps are not described in detail, so as not to unnecessarily limit the present disclosure. Preferred embodiments of the present disclosure will be described below in detail. However, in addition to the detailed description, the present disclosure may also be widely implemented in other embodiments. The scope of the present disclosure is not limited to the detailed description, and is defined by the claims.

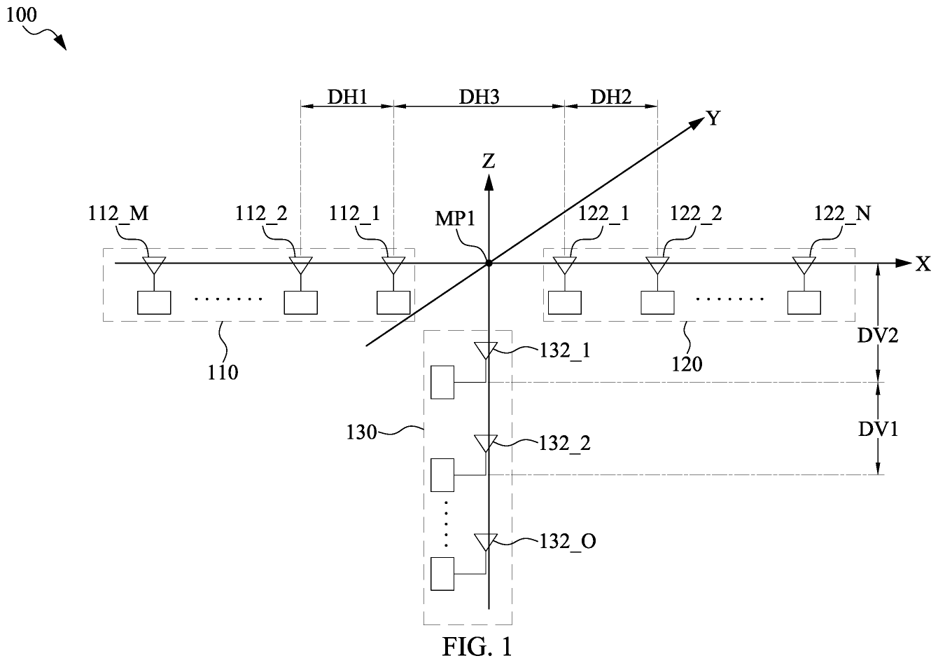

FIG. 1 shows a radar system 100 according to some embodiments of the present disclosure. In some embodiments, the radar system 100 may be a digital active phased array radar system in which an active electronically scanned array (AESA) is applied. The radar system 100 includes a first subarray 110, a second subarray 120, and a third subarray 130.

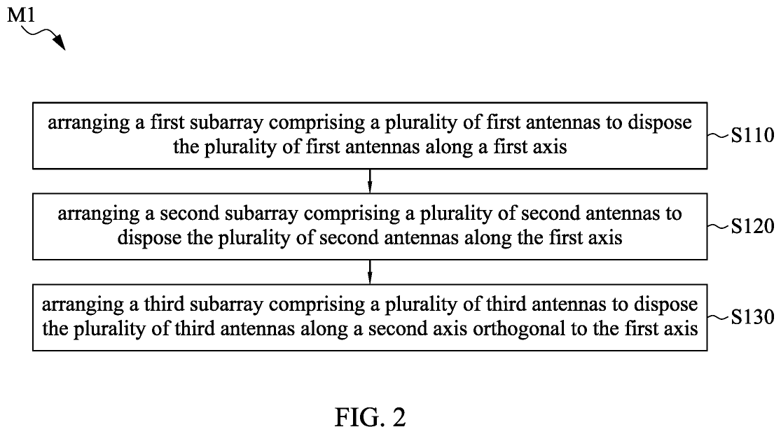

FIG. 2 shows a method M1 for scanning objects with the radar system 100 according to some embodiments of the present disclosure. In some embodiments, the method M1 includes steps S110 to S130 for arranging the first subarray 110, a second subarray 120, and a third subarray 130 so as to facilitate the scanning process.

Referring to FIG. 2 and also to FIG. 1, in step S110, the first subarray 110 including M1 first antennas 112_1 to 112_M is arranged so that the first antennas 112_1 to 112_M are disposed along a first axis. In step S120, the second subarray 120 including N second antennas 122_1 to 122_N is arranged so that the second antennas 122_1 to 122_N are disposed along the first axis. Also, the third subarray 130 including O third antennas 132_1 to 132_O is arranged so that the third antennas 132_1 to 132-O are disposed along a second axis orthogonal to the first axis. In the context of the present disclosure, the first axis can be the X axis, and the second axis can be the Z axis. Furthermore, M, N, and O can be integers greater than 1. In such case, the first subarray 110, the second subarray 120, and the third subarray 130 can form a T-shape radar. In some embodiments, M is equal to N, and in some embodiments, M, N and O are equal. For example, M, N, and O can be equal to 8. However, the present disclosure is not limited thereto.

In some embodiments, the first subarray 110 and the second subarray 120 can be configured as a plurality of transceivers. That is, the first subarray 110 can transmit and receive radio frequency (RF) signals through the first antennas 112_1 to 112_M, and the second subarray 120 can transmit and receive RF signals through the second antennas 122_1 to 122_N. In some embodiments, the third subarray 130 can be configured as a plurality of receivers. That is, the third subarray 130 can receive RF signals through the third antennas 132_1 to 132-O.

Furthermore, in some embodiments, a distance DHI between each two adjacent first antennas and a distance DH2 between each two adjacent second antennas are the same and can both be half a wavelength of the RF signal.

As shown in FIG. 1, the first antenna 112_1 in the first subarray 110 is adjacent to the second antenna 122_1 in the second subarray 120, and thus, a distance DH3 between the first antenna 112_1 and the second antenna 122_1 is a minimum distance between the first antennas 112_1 to 112_M in the first subarray 110 and the second antennas 122_1 to 122_N in the second subarray 120. In some embodiments, the distance DH3 is greater than or equal to the distance DH1. In some embodiments, if the distance DH3 is equal to the distance DH1, then the first subarray 110 and the second subarray 120 can be seen as a uniform linear array (ULA) transceiver. However, in some embodiments, if the distance DH3 is greater than the distance DH1, then the first subarray 110 and the second subarray 120 can be seen as a non-uniform linear array transceiver.

Furthermore, a distance DVI between each two adjacent third antennas is half of a wavelength of the RF signal. In some embodiments, the distance DVI is equal to the distance DH1 and the distance DH2. In addition, a distance DV2 between a third antenna 132_1 and a midpoint MP1 between the first antenna 112_1 and the second antenna 122_1 is greater than 0. In the present disclosure, the midpoint MPI between the first antenna 112_1 and the second antenna 122_1 is located at the reference point of the Cartesian coordinate system as shown in FIG. 1 for ease of explanation.

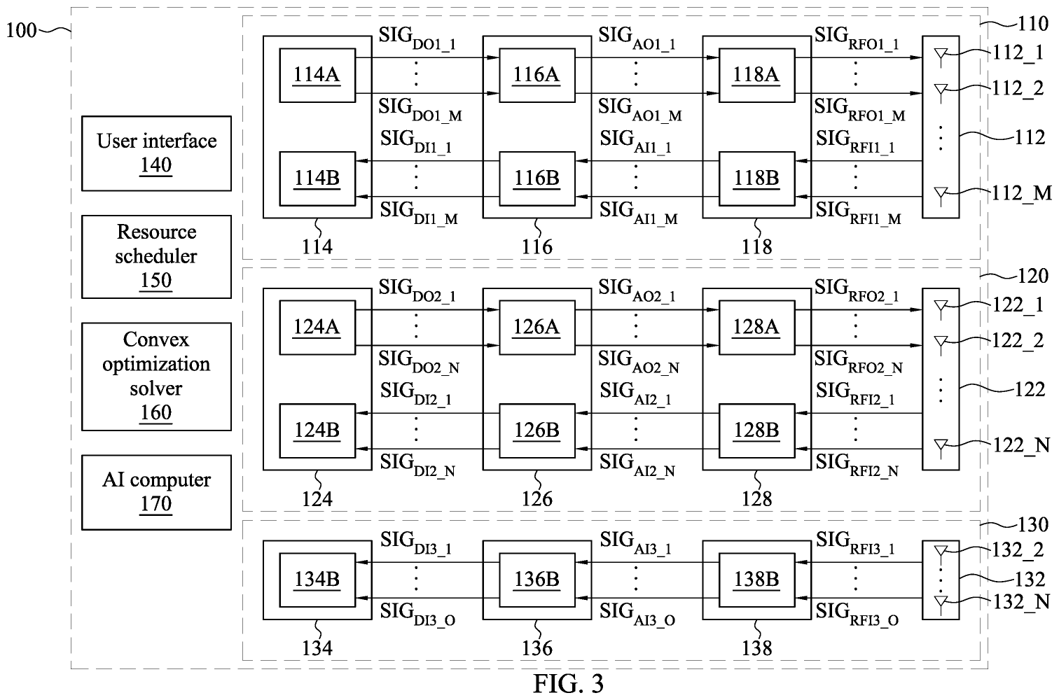

FIG. 3 shows functional blocks of the radar system 100 according to some embodiments of the present disclosure. As shown in FIG. 3, the first subarray 110 includes a phased array antennas 112, a digital signal and data processor (DSDP) 114, an analog front-end circuit 116, and a RF front-end circuit 118. The phased array antennas 112 includes the antennas 112_1 to 112_M. In some embodiment, the first subarray 110 and the second subarray 120 can be adopted as transceivers. For example, the DSDP 114 includes a digital transmitter assembly 114A and a digital receiver assembly 114B. The analog front-end circuit 116 includes an analog transmitter assembly 116A and an analog receiver assembly 116B. In addition, the RF front-end circuit 118 includes a RF transmitter assembly 118A and a RF receiver assembly 118B.

Similarly, the second subarray 120 includes a phased array antennas 122, a digital signal and data processor (DSDP) 124, an analog front-end circuit 126, and a RF front-end circuit 128. The phased array antennas 122 includes the antennas 122_1 to 122_N. The DSDP 124 includes a digital transmitter assembly 124A and a digital receiver assembly 124B. The analog front-end circuit 126 includes an analog transmitter assembly 126A and an analog receiver assembly 126B. In addition, the RF front-end circuit 128 includes a RF transmitter assembly 128A and a RF receiver assembly 128B.

In some embodiments, the third subarray 130 may be configured as a plurality of receivers. For example, the third subarray 130 includes a phased array antennas 132, a DSDP 134, an analog front-end circuit 136, and a RF front-end circuit 138. The phased array antennas 132 includes the antennas 132_1 to 132-O. The DSDP 134 includes a digital receiver assembly 134B. The analog front-end circuit 136 includes an analog receiver assembly 136B. In addition, the RF front-end circuit 138 includes a RF receiver assembly 138B.

When the radar system 100 is configured to emit RF signals for scanning objects, the digital transmitter assembly 114A can generate digital output signals SIG_{DO1_1} to SIG_{DO1_M} according to the required scanning scheme, the analog transmitter assembly 116A can convert the digital output signals SIG_{DO1_1} to SIG_{DO1_M}into analog output signals SIG_{AO1_1} to SIG_{AO1_M}, and the RF transmitter assembly 118A may convert the analog output signals SIG_{AO1-1} to SIG_{AO1_M} into RF output signals SIG_{RFO1_1} to SIG_{RFO1_M} that have a higher frequency for transmission. The phased array antennas 112 may adopt variable phase shifters and/or time delay controllers for controlling the phases of the RF output signals SIG_{RFO1_1} to SIG_{RFO1_M} emitted by the antennas 112_1 to 112_M.

Similarly, when the radar system 100 is configured to emit RF signals for scanning objects, the digital transmitter assembly 124A can generate digital output signals SIG_{DO2_1} to SIG_{DO2_N} according to the required scanning scheme, the analog transmitter assembly 126A can convert the digital output signals SIG_{DO2_1} to SIG_{DO2_N}into analog output signals SIG_{AO2_1} to SIG_{AO2_N}, and the RF transmitter assembly 128A may convert the analog output signals SIG_{AO2_1} to SIG_{AO2_N} into RF output signals SIG_{RFO2_1} to SIG_{RFO2_N} that have a higher frequency for transmission. The phased array antennas 122 may adopt variable phase shifters and/or time delay controllers for controlling the phases of the RF output signals SIG_{RFO2_1} to SIG_{RFO2_N} emitted by the antennas 122_1 to 122_N.

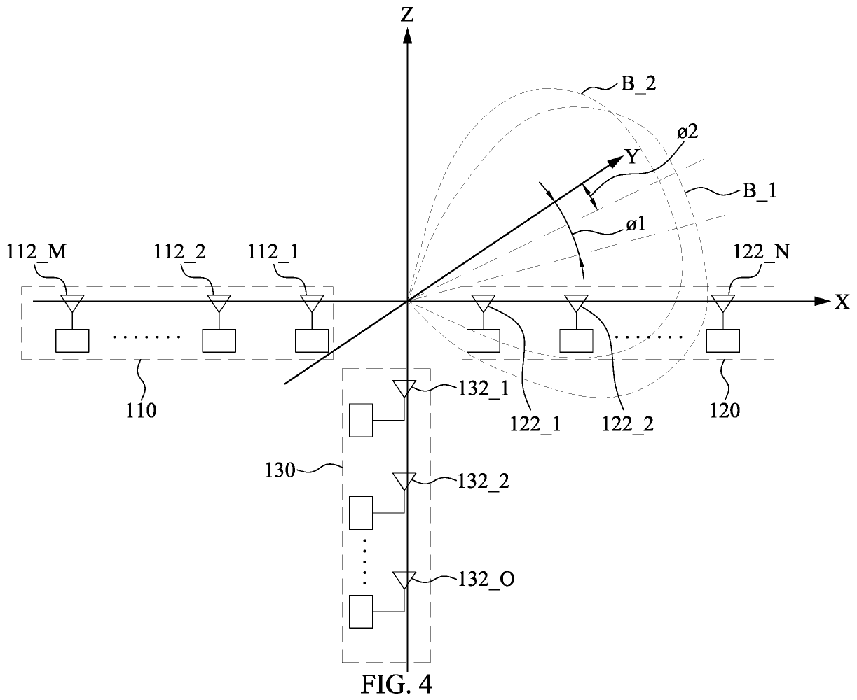

In some embodiments, by properly adjusting the phases and/or the amplitudes of the RF signals emitted by the antennas 112_1 to 112_M and the antennas 122_1 to 122_N, a RF beam that aims to an appointed direction can be formed. FIG. 4 shows the RF beams that are steered by the first subarray 110 and the second subarray 120 to different directions in different periods of time.

As shown in FIG. 4, the RF beams B_1 and B_2 can have a shape of fan. Furthermore, in the present embodiment, the first antennas 112_1 to 112_M and the second antennas 122_1 to 122_N are disposed along the first axis, and are facing along the direction of a third axis (e.g., Y axis). In such case, the Y axis would indicate the boresight direction of the radar system 100, and the RF fan beams B_1 and B_2 can be steered to have different azimuth angles φ1 and φ2 on the plane (e.g., the X-Y plane) formed by the first axis (e.g., X axis) and the third axis (e.g., Y axis) that is orthogonal to the first axis and the second axis (e.g., Z axis). Also, in such case, the normal vectors of main planes of the RF beams B_1 and B_2 have no vector component along the second axis.

In some embodiments, after a RF beam is radiated by the radar system 100, if the RF beam hit an object, the radar system 100 would receive the RF signals reflected from the object, and by performing the beamforming calculation and the Doppler processing according to the received RF signals, a position and a velocity of the object with respect to the radar system 100 can be derived.

In some embodiments, the first subarray 110, the second subarray 120, and the third subarray 130 can be receivers for receiving the reflected RF signals. In some embodiments, by beamforming the RF signals received by the first subarray 110 and the second subarray 120, an azimuth angle of the position of the object can be obtained. In such case, the receivers configured by the first subarray 110 and the second subarray 120 can be seen as horizontal receivers, and the beamforming of the RF signals received by the first subarray 110 and the second subarray 120 can be referred to the horizontal beamforming. In addition, by beamforming the RF signals received by the third subarray 130, an elevation angle of the position of the object can be obtained. In such case, the receivers configured by the third subarray 130 can be seen as vertical receivers, and the beamforming of the RF signals received by the third subarray 130 can be referred to the vertical beamforming.

Specifically, when the radar system 100 is configured to receive incoming signals, the RF receiver assemblies 118B, 128B, and 138B may convert the RF input signals SIG_{RFI1_1} to SIG_{RFI1_M}, SIG_{RFI2_1} to SIG_{RFI2_N}, and SIG_{RFI3_1} to SIG_{RFI3_O} to analog input signals SIG_{AI1_I} to SIG_{AI1_M}, SIG_{AI2_1} to SIG_{AI2_N}, and SIG_{AI3_1} to SIG_{AI3-O}. The analog receiver assemblies 116B, 126B, and 136B can convert the analog input signals SIG_{AI1-1} to SIG_{AI1_M}, SIG_{AI2_1} to SIG_{AI2_N}, and SIG_{AI3_1} to SIG_{AI3_O} into digital input signals SIG_{DI1_1} to SIG_{DI1_M}, SIG_{DI2_1} to SIG_{DI2_N}, and SIG_{DI3_1} to SIG_{DI3-O}. The digital receiver assemblies 114B, 124B, and 134B can perform a series of operations, such as front-end channel compensation, pre-averaging, matched filtering, down sampling, and Doppler processing, so as to facilitate the beamforming and derive the position and the velocity of the detected object. Since the radar system 100 can perform the scan process with 2 dimensional sparse antenna array (i.e., the antennas 112_1 to 112_M, 122_1 to 122_N, and 132_1 to 132-O), the hardware components required by the radar system 100 can be significantly reduced, which can benefit the radar system 100 in terms of reducing cost and space.

In some embodiments, a detectable scanning range of the radar system 100 may be related to the pulse duration for transmitting the RF output signals and the swath duration for receiving the RF input signals. For example, when scanning an object farer away from the radar system 100, a longer pulse duration for transmitting RF output signals having a wider bandwidth may be required to maintain an acceptable range resolution for detection. However, if the RF input signals requires a longer duration to complete transmission, then some of the nearby objects may not be able to be detected since the reflected RF signal may reach to the radar system 100 before the radar system 100 finishes transmitting the RF signal and change in to the receiving state. Therefore, in some embodiments, to expand the radar coverage while maintaining an acceptable performance (e.g., to meet the minimum signal-to-noise ratio (SNR) requirement), the radar system 100 may divide the full radar coverage into different detection distance ranges, and scan the different detection distance ranges respectively.

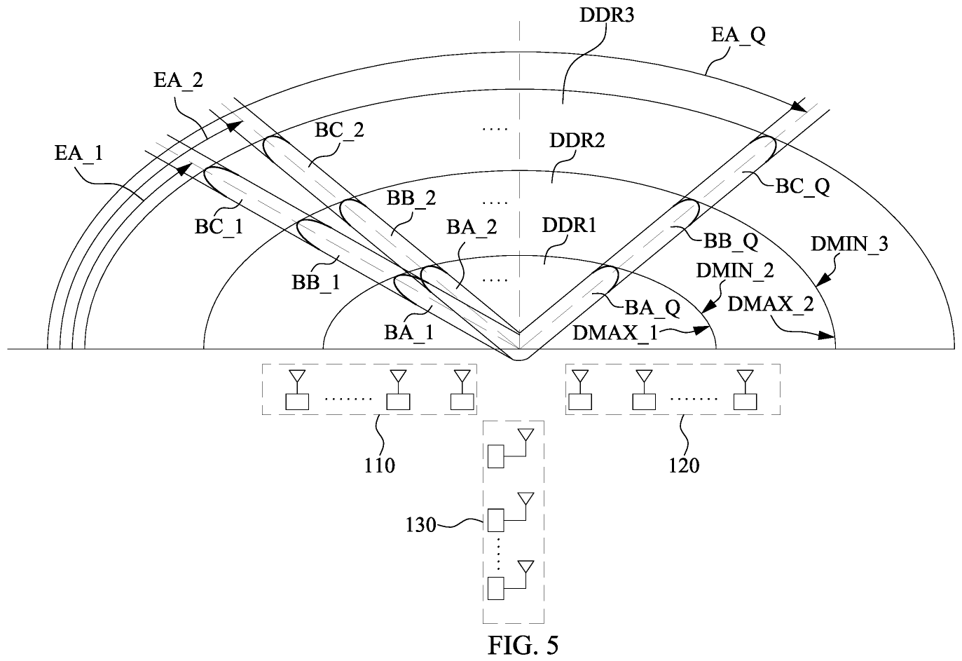

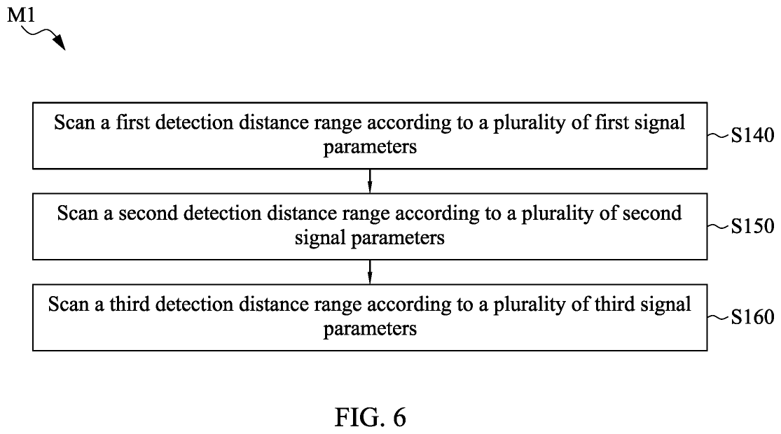

FIG. 5 shows a scanning scheme of the radar system 100 under a first scanning mode according to some embodiments of the present disclosure. In some embodiments, the first scanning mode can also be called as a “track-while-scan” mode. FIG. 6 shows steps of the method MI for scanning objects in a one-round scan interval under the first scanning mode according to some embodiments of the present disclosure. In some embodiments, the one-round scan interval under the first scanning mode represents the time the radar system 100 needs to take for scanning its full radar coverage under the first scanning mode.

As shown in FIG. 6, for each one-round scan interval, the method M1 further includes steps S140 to S160 for scanning different detection distance ranges DDR1, DDR2, and DDR3 respectively with the corresponding signal parameters. In some embodiments, the method Ml is performed by utilizing the first subarray 110 and the second subarray 120 as transceivers and utilizing the third subarray 130 as receivers.

In step S140, the radar system 100 may scan objects in the first detection distance range DDR1 with a plurality of first RF beams BA_1 to BA_Q corresponding to a plurality of azimuth angles EA1 to EA_Q as shown in FIG. 5, where Q is an integer greater than 1. In step S150, the radar system 100 may scan objects in the second detection distance range DDR2 with a plurality of second RF beams BB_1 to BB_Q corresponding to the azimuth angles EA_1 to EA_Q, and in step S160, the radar system 100 may scan objects in the third detection distance range DDR3 with a plurality of third RF beams BC_1 to BC_Q corresponding to the azimuth angles EA1 to EA_Q.

Furthermore, as shown in FIG. 5, a maximum distance DMAX_1 measured from the radar system 100 to each detectable location in the first detection distance range DDR1 is less than or equal to a minimum distance DMIN_2 measured from the radar system 100 to each detectable location in the second detection distance range DDR2. Similarly, a maximum distance DMAX_2 measured from the radar system 100 to each detectable location in the second detection distance range DDR2 is less than or equal to a minimum distance DMIN_3 measured from the radar system 100 to each detectable location in the third detection distance range DDR3.

In some embodiments, Q can be 17. However, the present disclosure is not limited thereto. Furthermore, in some embodiments, the radar system 100 may detect more or less number of detection distance ranges. In addition, the radar system 100 may scan the detection distance ranges in any predetermined orders. For example, the radar system 100 may scan the second detection distance range DDR2 before scanning the first detection distance range DDR1.

Furthermore, in some embodiments, the radar system 100 may further include a user interface 140 (e.g., a graphic user interface, GUI) for receiving commands from a user to define the detection distance ranges. For example, the interface 140 may allow the user to define the number of detection distance ranges.

In some embodiments, as the location and the posture of the radar system 100 are fixed without mechanical motion during the scanning process, the radar coverage of the radar system 100 can be indicated by a field of view (FoV) in terms of a minimum scannable range (e.g., 100 meters due to the existence of a blind zone), a maximum scannable range (e.g., 5000 meters), an azimuth coverage (e.g., from −60 to 60 degrees), and an elevation coverage (e.g., from −60 to 60 degrees). In some embodiments, the azimuth coverage and the elevation coverage may be determined by the coverage range of the RF beams that have the minimum acceptable power values. In addition, the blind zone can be determined by the distance that light travels during the duration between the time the radar system 100 start to transmit the RF output signal and the time the radar system 100 start to receive the RF input signal.

In some embodiments, the user interface 140 may also allow the user to define a scan volume within the radar coverage of the radar system 100. For example, the user may select the azimuth coverage to be −45 to 45 degrees. In such case, the one-round scan interval for scanning the user-defined scan volume can be shortened to be shorter than the one-round scan interval for scanning the full radar coverage of the radar system 100.

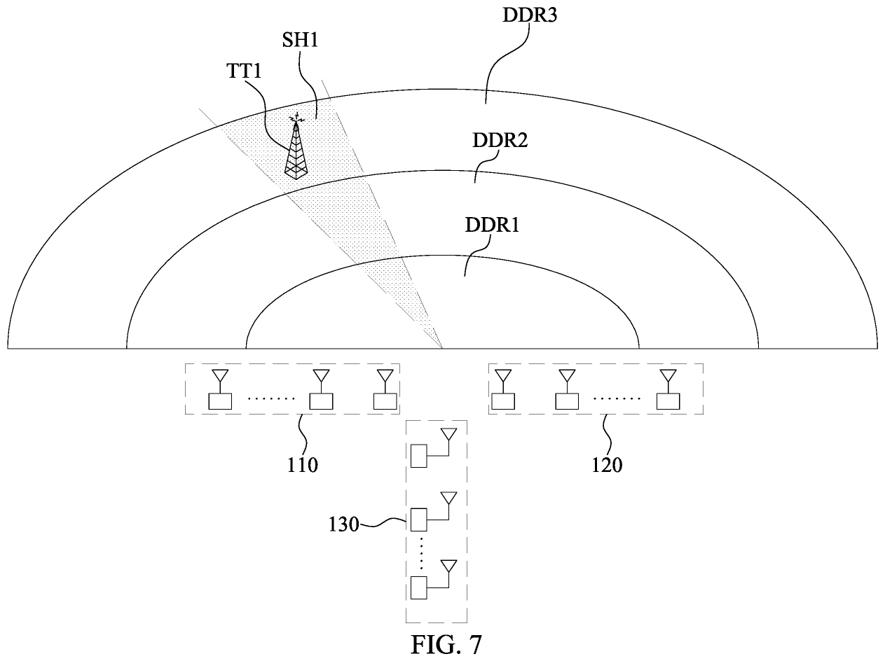

Furthermore, in some embodiments, the user interface 140 may allow the user to define a shielding sector. FIG. 7 shows a scanning scheme of the radar system 100 under the first scanning mode with a shielding sector SHI according to some embodiments of the present disclosure. As shown in FIG. 7, the scanning volume covered by the radar system 100 includes a telecommunications tower TT1 that May transmit and/or receive RF signals. In such case, to reduce the interference, it is preferred not to emit RF beams toward the telecommunications tower TT1 and not to receive RF signals from the direction where the telecommunications tower TT1 locate. Thus, the user may define the shielding sector SHI that includes the telecommunications tower TT1 so as to instruct the radar system 100 to avoid scanning such region.

In some embodiments, to ensure that the radar system 100 can scan the detection distance ranges DDR1, DDR2, and DDR3 with SNRs satisfying the same acceptable requirement, the radar system 100 may scan the different detection distance ranges DDR1, DDR2, and DDR3 according to different signal parameters. For example, a length of the pulse duration for scanning the first detection distance range DDR1 may be different from the a length of the pulse duration for scanning the second detection distance range DDR2, and a length of the swath duration for scanning the first detection distance range DDR1 may be different from the a length of the swath duration for scanning the second detection distance range DDR2. Therefore, in some embodiments, before the radar system 100 perform steps S140 to S160 to scan the detection distance ranges DDR1, DDR2, and DDR3, the radar system 100 may have to derive the corresponding signal parameters used for scanning the detection distance ranges DDR1, DDR2, and DDR3 in advance.

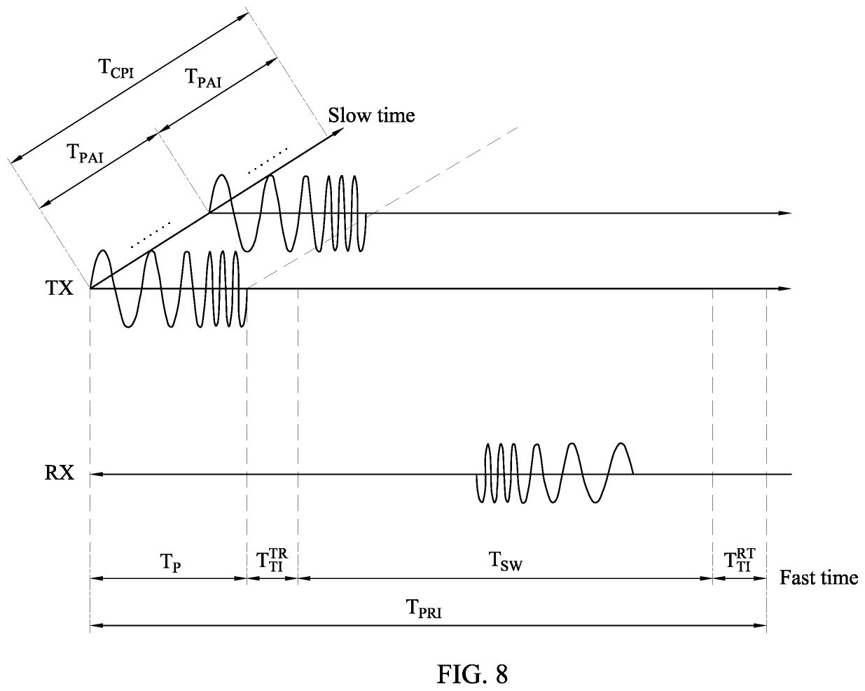

FIG. 8 shows a timing diagram of RF signals transmitted by a transmitter TX and RF signals received by a receiver RX of the radar system 100 when scanning one azimuth angle in one detection distance range according to some embodiments of the present disclosure. In FIG. 8, a fast time axis (horizontal axis) shows a pulse repetition interval (PRI) T_{PRI} that refers to the interval of time required for the radar system 100 to send two consecutive RF signals, and a slow time axis (vertical axis) shows a coherent pulse interval (CPI) T_{CPI} that is formed by a plurality of PRIs T_{PRI}.

As shown in FIG. 8, the PRI T_{PRI}. includes a pulse duration T_{P} and a swath duration T_{SW} behind the pulse duration T_{P}. The pulse duration T_{P} is for the transmitter TX to transmit a RF beam toward a corresponding azimuth angle, and the swath duration T_{SW} is for the receiver RX to receive the RF signals reflected by the objects. In some embodiments, the radar system 100 may need some time to switch the first subarray 110 and the subarray 120 from a transmitting state to a receiving state and from the receiving state to the transmitting state. Therefore, in FIG. 8, a transient interval T_{TI}^{TR} between the pulse duration T_{P} and the swath duration T_{SW} is required for the radar system 100 to switch from a transmitting state to a receiving state, and a transient interval T_{TI}^{RT} between the swath duration T_{SW} and a next pulse duration (not shown) is required for the radar system 100 to switch from the receiving state to the transmitting state. In such case, the PRI T_{PRI} may include the pulse duration T_{P}, the swath duration T_{SW}, the transient interval T_{TI}^{TR}, and the transient interval T_{TI}^{RT}.

Furthermore, in some embodiments, the radar system 100 may emit coherent RF beams toward the same azimuth angle and receive the corresponding reflected RF signals several times during one CPI T_{CPI}. The coherent reflected RF signals received in multiple times can be used for coherent integration so as to improve the accuracy of object detection. Furthermore, since noises in environment are usually random and have an average value near zero, the reflected RF signals received in successive PRIS may be grouped and averaged so as to distinguish the RF input signals reflected by the object from the noises. That is, before the RF input signals are fed for coherent integration, an averaging process may be performed to average the RF input signals received in some successive PRIs. In some embodiments, the PRIs that are grouped for averaging the received RF signals can be combined and called a pulse averaging interval (PAI) T_{PAI}. In such case, as shown in FIG. 7, each CPI T_{CPI} may include a plurality of PAsS T_{PAI} for coherent integration, and each PAI T_{PAI} may include a plurality of PRIs T_{PRI} for averaging process.

In some embodiments, for a d^{th} detection distance range, the radar system 100 may need to determine signal parameters including: a number N_{S}^{P}[d] of samples per pulse duration, a number N_{S}^{SW}[d] of samples per swath duration, a number N_{S}^{PRI}[d] of samples per PRI, a number N_{PRI}^{PAI}[d] of PRIs per PAI, a number N_{PAI}^{CPI}[d] of PAIs per CPI, a minimum detectable range R^{min}[d] of the d^{th} detection distance range, and a maximum detectable range Rₘₐₓ[d] of the d^{th} detection distance range, where d is a positive integer. For example, in the embodiment shown in FIG. 5, d can be 1, 2, or 3.

In some embodiments, since the sampling intervals of the analog-to-digital converters in the analog front-end circuit 116, 126, and 136 are the same and are known factors, by determining the signal parameters N_{S}^{P}[d], N_{S}^{SW}[d], N_{S}^{PRI}[d], N_{PRI}^{PAI}[d], and N_{PAI}^{CPI}[d], the time length of the pulse duration T_{P}[d], the time length of the swath duration T_{SW}[d], the time length of the PRI T_{PRI}[d], the time length of the PAI T_{PAI}[d], and the time length of the CPI T_{CPI}[d] corresponding to the d^{th} detection distance range can be obtained. For example, if the sampling interval is denoted as T_{S}, then the time length of the pulse duration T_{P}[d] would be equal to T_{S}·N_{S}^{P}[d], the time length of the swath duration T_{SW}[d] would be equal to T_{S}·N_{S}^{SW}[d], the time length of the PRI T_{PRI}[d] would be equal to T_{S}·N_{S}^{PRI}[d], the time length of the PAI T_{PAI}[d] would be equal to T_{PRI}[d]·N_{PRI}^{PAI}[d], and the time length of the CPI T_{CPI}[d] would be equal to T_{PAI}[d]·N_{PAI}^{CPI}[d].

In some embodiments, the radar system 100 may include a resource scheduler 150 for deriving the signal parameters N_{S}^{P}[d], N_{S}^{SW}[d], N_{S}^{PRI}[d], N_{PRI}^{PAI}[d], N_{PAI}^{CPI}[d] , Rₘᵢₙ[d], and Rₘₐₓ[d] for the d^{th} detection distance range. In some embodiments, the resource scheduler 150 can derive the signal parameters by optimizing the one-round scan interval T_{scan} while satisfying constraints related to the signal parameters. Specifically, if the radar coverage is divided into N_{DDR} detection distance ranges, and for each detection distance range, the radar system 100 is requested to emit RF beams towards N_{beam} azimuth angles, then the one-round scan interval T_{scan} would be equal to Σ_{d=1}^{N}^{_{DDR}} N_{beam}·T_{CPI}, where N_{DDR} and N_{beam} are positive integers. For example, in the embodiment shown in FIG. 5, N_{DDR} is equal to 3, and N_{beam} is equal to Q (i.e., 17). In some embodiments, the objective of the resource scheduler 150 is to minimize the one-round scan interval T_{scan} subject to the constraints (1) to (9) as listed below.

(1) The one-round scan interval T_{scan} should be less than a required update time. In some embodiments, the required update time can be determined by the user, and can be inputted to the radar system 100 through the user interface 140. In some embodiments, the required update time should also include the hardware transient time (e.g., T_{TI}^{TR} and T_{TI}^{RT}), the user command latency, and the computational delay, etc.

(2) The minimum detectable distance Rₘᵢₙ[d] of the d^{th} detection distance range shall be equal to half of a distance that a light travels during a sum of a pulse duration T_{P}[d] and a transient duration T_{TI}^{TR}. That is, the minimum detectable distance Rₘᵢₙ[d] should be equal to c(T_{P}[d]+T_{TI}^{TR})/2, where c is the speed of light.

(3) The maximum detectable distance Rₘₐₓ[d] of the d^{th} detection distance range shall be equal to half of a distance that a light travels during a PRI T_{PRI}[d] minus a transient duration T_{TI}^{RT} and the pulse duration T_{P}[d]. That is, the maximum detectable distance Rₘₐₓ should be equal to c(T_{PRI}[d]−T_{TI}^{RT}−T_{P}[d])/2.

(4) The range between minimum detectable distance Rₘᵢₙ[1] of the first detection distance range and the maximum detectable distance Rₘₐₓ[N_{DDR}] of the last detection distance range shall embrace the scannable range coverage defined by the FoV.

(5) For each detection distance range, the minimum achievable SNR of the receivers configured by the first subarray 110 and the second subarray 120, and the minimum achievable SNR of the receivers configured by the third subarray 130 shall both be larger than the minimum SNR requirement, for example, but not limited to, 13 dB.

In some embodiments, the minimum achievable SNR SNRₘᵢₙ^{(H)}[d] of the receivers configured by the first subarray 110 and the second subarray 120 for the d^{th} detection distance range can be calculated by the received target horizontal signal power dividing the sum of noises received by each receiver in the first subarray 110 and the second subarray 120. For example, minimum achievable SNR SNRₘᵢₙ^{(H)}[d] can be formulated by formula (F1) as below.

$${SNR}_{min}^{( H )} [ d ] = \frac{{P}_{R}^{( H )} [ d ]}{{N}_{RX}^{( H )} {P}_{N}} = \frac{{P}_{rad} {σ}_{min} [ d ] {λ}^{2} {\sum }_{j = 1}^{{N}_{RX}^{( H )}} {G}_{R , j}^{( H )}}{{( 4 π )}^{3} {R}_{max}^{4} [ d ] {N}_{RX}^{( H )} {P}_{N}} \cdot \frac{{G}^{( H )} [ d ]}{{L}^{( H )}} \qquad ( F1 )$$

In formula (F1), P_{R}^{(H)}[d] represents the received target signal power after horizontally linear processing for the d^{th} detection distance range, N_{RX}^{(H)} (represents the number of horizontal receivers (i.e., the sum of the number of antennas 112_1 to 112_M in the first subarray 110 and the number of antennas 122_1 to 122_N in the second subarray 120, that is M+N), and P_{N} represents the theoretically thermal noise power of each receiver. In some embodiments, P_{N} equals to kTFB, where k is the Boltzmann constant, T is the standard temperature plus the current circuit temperature, F is the noise figure, and B is the receiving bandwidth in Hertz. Furthermore, P_{rad} represents the radiation power of the radar system 100 and can computed as P_{rad}=P_{TX}Σᵢ^{N}^{_{TX}}G_{T,i}, where P_{TX} is the peak power per transmitter, N_{TX} is the number of transmitters (i.e., the sum of the number of antennas 112_1 to 112_M in the first subarray 110 and the number of antennas 122_1 to 122_N in the second subarray 120, that is M+N), and G_{T,i} is the antenna gain of the i^{th} transmitter. In addition, σₘᵢₙ[d] is the minimum supportable radar cross section (RCS) of the d^{th} detection distance range in square meter, and Rₘₐₓ[d] is the maximum detectable distance of the d^{th} detection distance range in meter. Also, G_{R,j}^{(H)} is the antenna gain of the j^{th} horizontal receiver, G^{(H)}[d] is the overall horizontal processing gain, and L(H) is the overall system loss in terms of the horizontal aspect, which involves direct-sum loss, straddle loss, beam pattern loss due to diverse directional angles, and any imperfect responses. In some embodiments, the overall horizontal processing gain G^{(H)}[d] can be formulated by formula (F2) as below.

$${G}^{( H )} [ d ] = {N}_{TX} \cdot {N}_{PRI}^{PAI} [ d ] \cdot {N}_{S}^{P} [ d ] \cdot {N}_{PAI}^{CPI} [ d ] \cdot {N}_{RX}^{( H )} , \qquad ( F2 )$$

In some embodiments, the minimum achievable SNR SNRₘᵢₙ^{(V)}[d] of the receivers configured by the third subarray 130 for the d^{th} detection distance range can be calculated by the received target vertical signal power dividing the sum of noises received by each receiver in the third subarray 130. For example, minimum achievable SNR SNRₘᵢₙ^{(V)}[d] can be formulated by formula (F3) as below.

$${SNR}_{min}^{( V )} [ d ] = \frac{{P}_{R}^{( V )} [ d ]}{{N}_{RX}^{( V )} {P}_{N}} = \frac{{P}_{rad} {σ}_{min} [ d ] {λ}^{2} {\sum }_{j = 1}^{{N}_{RX}^{( V )}} {G}_{R , j}^{( H )}}{{( 4 π )}^{3} {R}_{max}^{4} [ d ] {N}_{RX}^{( V )} {P}_{N}} \cdot \frac{{G}^{( H )} [ d ]}{{L}^{( H )}} \qquad ( F3 )$$

In formula (F3), P_{R}^{(V)} represents the received target signal power after vertically linear processing, N_{RX}^{(V)} represents the number of vertical receivers (i.e., the number of antennas in the third subarray 130, that is O), and P_{N} represents the theoretically thermal noise power of one receiver. Furthermore, P_{rad} represents the radiation power of the radar system 100, σₘᵢₙ[d] is the minimum supportable radar cross section (RCS) of the d^{th} detection distance range in square meter, and Rₘₐₓ[d] is the maximum detectable distance for the d^{th} detection distance range in meter. Also, is the antenna gain of the j^{th} vertical receiver, G^{(V)}[d] is the overall vertical processing gain for the d^{th} detection distance range, and L^{(V)} is the overall system loss in terms of the vertical aspect. In some embodiments, the overall vertical processing gain G^{(V)}[d] equals to N_{TX}·N_{PRI}^{PAI}[d]·N_{S}^{P}[d]·N_{PAI}^{CPI}·N_{RX}^{(V)}.

In some embodiments, for each detection distance range, the resource scheduler may determine the signal parameters N_{PRI}^{PAI}[d], N_{S}^{P}[d], N_{PAI}^{CPI}[d], Rₘₐₓ[d], and σₘᵢₙ[d] correspondingly so that the SNRs formulated by (F1) and (F3) can meet the minimum requirements.

(6) The maximum supportable Doppler shift for each detection distance range shall be less than 0.5/T_{PAI}[d] for unambiguous Doppler coverage.

(7) The maximum range migration width for the d^{th} detection distance range shall be less than the range resolution bin Rᵣₑₛₒ. That is, the condition shown by formula (F4) shall be hold.

$$\frac{λ}{2} {f}_{max} [ d ] {T}_{CPI} [ d ] < {R}_{reso} = \frac{c α [ d ] {T}_{s}}{2} \qquad ( F4 )$$

In formula (F4), α[d] is the down-sampling factor and is greater than or equal to 1.

(8) The main lobe width on a Doppler spectrum shall be under control. For example, the main lobe width on a Doppler spectrum shall be smaller than the maximum allowable main lobe width Fₘₐₓ^{width}[d]. In some embodiments, the shorter T_{CPI}[d] may make the main lobe width 2/T_{CPI}[d] wider, and thus, the condition shown by formula (F5) shall be hold.

$$\frac{2}{{T}_{CPI} [ d ]} \leq {F}_{max}^{width} [ d ] \qquad ( F5 )$$

(9) For each detection distance range, the swath duration T_{SW}[d] is greater than the pulse duration T_{P}[d] but less than or equal to the PRI T_{PRI}[d] minus the pulse duration T_{P}[d], the transient duration T_{TI}^{TR}[d], and the transient duration T_{TI}^{RT}[d] (i.e., T_{SW}[d]≤T_{PRI}[d]−T_{P}[d]−T_{TI}^{TR}[d]−T_{TI}^{RT}[d]).

In some embodiments, more constraints may be added to further ensure the performance of the radar system. In addition, in some embodiments, the radar system 100 may further include a convex optimization solver 160, which can be associated with the resource scheduler 150 so as to assist the resource scheduler 150 to find the optimal signal parameters. In some embodiments, the optimization problems can be formulated and built in the radar system 100, and the convex optimization solver 160 can be a hardware accelerator that can speed up the calculation for the formulated convex optimization.

Furthermore, in the first scanning mode, when an emerging target is successfully detected, a tracking function can be initiated to track the position of the target and a predicting function can also be initiated to predict the next position of the target. After each one-round scan interval, the tracking result can be updated if the target is again detected under pairing constraints, otherwise, the current tracking record can be discarded and a new tracking record may be established. In some embodiments, the radar system 100 may further include an artificial intelligence (AI) computer 170. As the radar system 100 may continually receiving huge amounts of data, the AI computer 170 may assist in recognizing the features of target objects, the characteristics of the clutter and the behavior of the jammer so as to modeling the environment and tuning the variables used by the DSDPs 116, 126, and 136 for improving the performance of the radar system 100.

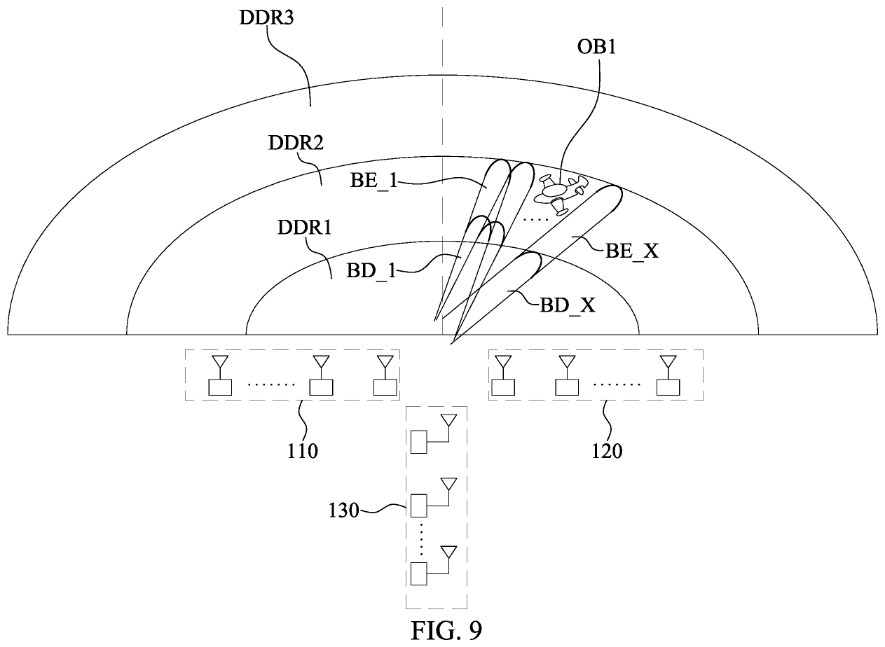

In some embodiments, in addition to the first scanning mode (i.e., the track-while-scan mode), the radar system 100 may further support a second scanning mode. FIG. 9 shows a scanning scheme of the radar system 100 under the second scanning mode according to some embodiments of the present disclosure.

In some embodiments, the second mode may also be called as a “shooting” mode, which intends to facilitate firing on threatening targets with a high target tracking update rate. As shown in FIG. 9, the second mode narrows the scanning volume according to the target approaching direction. For example, the first subarray 110 and the second subarray 120 may transmit a plurality of RF beams BD_1 to BD_X and BE_1 to BE_X toward different azimuth angles according to signal parameters related to at least a detected position or an approaching direction of a target object OB1. Each time after a RF beam of the RF beams BD_1 to BD_X is transmitted, the first subarray 110, the second subarray 120, and the third subarray 130 may enter the listening state for receiving the incoming RF signals to detect the target object OB1.

In some embodiments, X is an integer greater than 1 and smaller than Q. For example, Q can be 17 and X can be 3. That is, the radar system 100 may focus on scanning the region near the detected position of the target object OB1; therefore, the RF beams BD_1 to BD_X are aiming to fewer azimuth angles than the RF beams BA_1 to BA_Q. Also, in the second scanning mode, as the target object OBI is only threatening when approaching, the radar system 100 may only scan the detection distance ranges DDR1 and DDR2 that on the predicted moving direction of the target object OB1 and omit the detection distance range DDR3 that is behind the target object OB1. As a result, the scanning volume covered by the second scanning mode can be smaller than the scanning volume covered by the first scanning mode. Furthermore, since the scanning volume is smaller, the one-round scan interval of the second scanning mode is also shorter than the one-round scan interval of the first scanning mode, thereby allowing the second scanning mode to provide a higher updating rate.

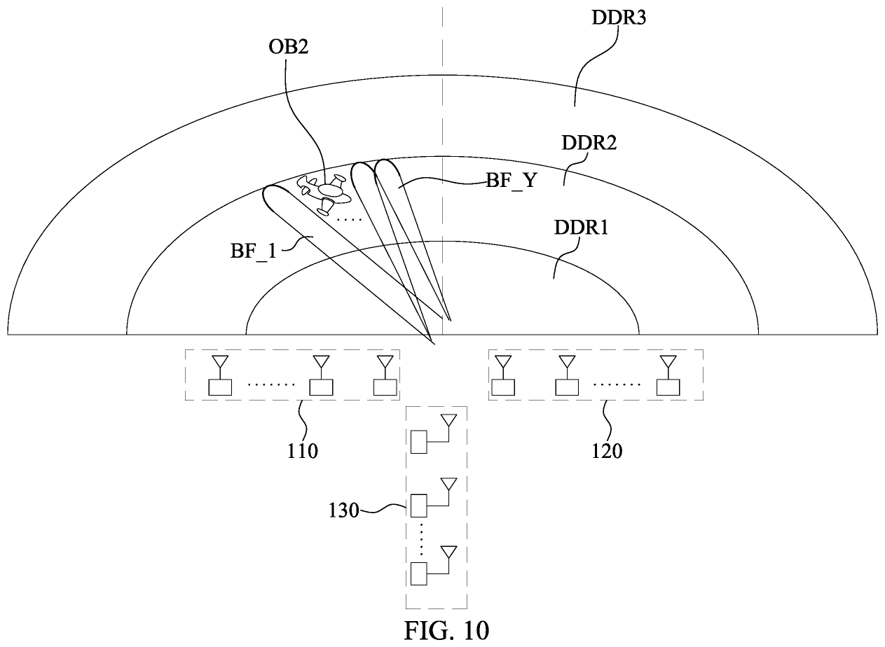

In some embodiments, the radar system 100 may further support a third scanning mode that is similar to the second scanning mode. The third scanning mode can also be called as a “spotlight” mode. FIG. 10 shows a scanning scheme of the radar system 100 under the third scanning mode according to some embodiments of the present disclosure.

As shown in FIG. 10, the radar system 100 may emit only few RF beams BF_1 to BF_Y (e.g., Y is equal to 3) to detect a chosen target OB2. Specifically, the radar system 100 can predict the next target localization based on the current and previous tracking results, and will only scan the region near the next target localization.

In some embodiments, the radar system 100 may allow the user to select the target objects OB1 and/or OB2 from a plurality of detected objects, and to switch the first scanning mode to the second scanning mode or the third scanning mode. In addition, in some embodiments, the signal parameters corresponding to the detection distance ranges DDR1, DDR2, and DDR3 that are derived by the resource scheduler 150 for the first scanning mode can also be adopted by the second scanning mode and the third scanning mode.

In summary, the radar system and the method for scanning objects provided by the embodiments of the present disclosure can adopt a 2-dimensional sparse antenna array arranged in a T-shaped so as to reduce the required hardware components. Furthermore, since the scanning process can be performed in multiple detection distance ranges according to corresponding signal parameters, the radar coverage can be expanded and the accuracy can be maintained.

Although the present disclosure and its advantages have been described in detail, it should be understood that various changes, substitutions and alterations can be made herein without departing from the spirit and scope of the disclosure as defined by the appended claims. For example, many of the operations discussed above can be implemented in different methodologies and replaced by other operations, or a combination thereof.

Moreover, the scope of the present application is not intended to be limited to the particular embodiments of the operation, machine, manufacture, composition of matter, means, methods and steps described in the specification. As one of ordinary skill in the art will readily appreciate from the present disclosure, operations, machines, manufacture, compositions of matter, means, methods, or steps, presently existing or later to be developed, that perform substantially the same function or achieve substantially the same result as the corresponding embodiments described herein, may be utilized according to the present disclosure. Accordingly, the appended claims are intended to include within their scope such operations, machines, manufacture, compositions of matter, means, methods, and steps.

What is claimed is:

1. A radar system, comprising:
a first subarray comprising a plurality of first antennas disposed along a first axis;
a second subarray comprising a plurality of second antennas disposed along the first axis; and
a third subarray comprising a plurality of third antennas disposed along a second axis orthogonal to the first axis;
wherein in a first scanning mode for scanning a radar coverage of the radar system, the radar system utilizes the first subarray and the second subarray as radio frequency (RF) signal transceivers and utilizes the third subarray as a RF signal receiver to:
scan a first detection distance range according to a plurality of first signal parameters; and
scan a second detection distance range according to a plurality of second signal parameters;
wherein a maximum distance measured from the radar system to each detectable location in the first detection distance range is less than or equal to a minimum distance measured from the radar system to each detectable location in the second detection distance range.

2. The radar system of claim 1, wherein during a process of the radar system scanning the first detection distance range:
the first subarray and the second subarray are configured to transmit a plurality of first RF beams toward a plurality of first azimuth angles in a plurality of first pulse durations respectively; and
the first subarray, the second subarray, and the third subarray are configured to receive a plurality of first incoming signals in a plurality of first swath durations to detect objects within the first detection distance range, wherein each of the plurality of first swath durations is behind a corresponding one of the plurality of first pulse durations;
wherein the plurality of first azimuth angles are defined on a plane formed by the first axis and a third axis orthogonal to the first axis and the second axis.

3. The radar system of claim 2, wherein each of the plurality of first RF beams is in a fan shape, and a normal vector of a main plane of each of the plurality of first RF beams has no vector component along the second axis.

4. The radar system of claim 2, wherein during a process of the radar system scanning the second detection distance range:
the first subarray and the second subarray are configured to transmit a plurality of second RF beams toward a plurality of second azimuth angles in a plurality of second pulse durations respectively; and
the first subarray, the second subarray, and the third subarray are configured to receive a plurality of second incoming signals in a plurality of second swath durations to detect objects within the second detection distance range, wherein each of the plurality of second swath durations is behind a corresponding one of the plurality of second pulse durations.

5. The radar system of claim 4, wherein the number of first azimuth angles is equal to the number of second azimuth angles.

6. The radar system of claim 4, wherein in a second scanning mode for scanning at least one part of the radar coverage of the radar system:
the first subarray and the second subarray are configured to transmit a plurality of third RF beams toward a plurality of third azimuth angles according to a position information of a target object derived in the first scanning mode; and
the first subarray, the second subarray, and the third subarray are configured to receive a plurality of third incoming signals to detect the target object;
wherein a one-round scan interval of the second scanning mode is shorter than a one-round scan interval of the first scanning mode.

7. The radar system of claim 6, wherein the position information of the target object includes a detected position of the target object and a moving direction of the target object.

8. The radar system of claim 6, wherein the number of third azimuth angles is less than each of the number of first azimuth angles and the number of second azimuth angles.

9. The radar system of claim 6, further comprising a user interface configured to receive commands from a user to select the target object from a plurality of detected objects, and to switch from the first scanning mode to the second scanning mode.

10. The radar system of claim 1, wherein the plurality of first signal parameters comprise at least one of: a number of samples per pulse duration, a number of samples per swath in a pulse repetition interval (PRI), a number of samples per the PRI, a number of PRIs per pulse averaging interval (PAI), a number of PAIs per coherent processing interval (CPI), a minimum detectable range of the first detection distance range, or a maximum detectable range of the first detection distance range.

11. The radar system of claim 1, further comprising a resource scheduler configured to derive the plurality of first signal parameters and the plurality of second signal parameters by optimizing a one-round scan interval of the first scanning mode to be shortest while satisfying a plurality of constraints related to the plurality of first signal parameters and the plurality of second signal parameters.

12. The radar system of claim 1, further comprising an artificial intelligence (AI) computer configured to recognize detected objects, characteristics of clutters, and behaviors of jammers within the first detection distance range and the second detection distance range.

13. The radar system of claim 1, wherein a distance between each two adjacent first antennas in the plurality of first antennas is equal to a half wavelength of a RF signal used for scanning, and a minimum distance between a first antenna in the plurality of first antennas and a second antenna in the plurality of second antennas is equal to or greater than the half wavelength of the RF signal.

14. A method for scanning objects with a radar system comprising a first subarray, a second subarray, and a third subarray, the method comprising:
arranging the first subarray comprising a plurality of first antennas to dispose the plurality of first antennas along a first axis;
arranging the second subarray comprising a plurality of second antennas to dispose the plurality of second antennas along the first axis;
arranging the third subarray comprising a plurality of third antennas to dispose the plurality of third antennas along a second axis orthogonal to the first axis;
in a first scanning mode for scanning a radar coverage of the radar system, utilizing the first subarray and the second subarray as radio frequency (RF) signal transceivers and utilizing the third subarray as a RF signal receiver to:
scan a first detection distance range according to a plurality of first signal parameters; and
scan a second detection distance range according to a plurality of second signal parameters;
wherein a maximum distance measured from the radar system to each detectable location in the first detection distance range is less than or equal to a minimum distance measured from the radar system to each detectable location in the second detection distance range.

15. The method of claim 14, wherein the step to scan the first detection distance range according to the plurality of first signal parameters comprises:
arranging the first subarray and the second subarray to transmit a plurality of RF beams toward a plurality of first azimuth angles in a plurality of first pulse durations; and
arranging the first subarray, the second subarray, and the third subarray to receive a plurality of first incoming signals in a plurality of first swath durations to detect objects within the first detection distance range, wherein each of the plurality of first swath durations is behind a corresponding one of the plurality of first pulse durations;
wherein the plurality of first azimuth angles are defined on a plane formed by the first axis and a third axis orthogonal to the first axis and the second axis.

16. The method of claim 15, wherein the step to scan the second detection distance range according to the plurality of second signal parameters comprises:
arranging the first subarray and the second subarray to transmit a plurality of second RF beams toward a plurality of second azimuth angles in a plurality of second pulse durations; and
arranging the first subarray, the second subarray, and the third subarray to receive a plurality of second incoming signals in a plurality of second swath durations to detect objects within the second detection distance range, wherein each of the plurality of second swath durations is behind a corresponding one of the plurality of second pulse durations.

17. The method of claim 16, further comprising in a second scanning mode for scanning at least one part of the radar coverage of the radar system:
arranging the first subarray and the second subarray to transmit a plurality of third RF beams toward a plurality of third azimuth angles according a position information of a target object derived in the first scanning mode; and
arranging the first subarray, the second subarray, and the third subarray to receive a plurality of third incoming signals to detect the target object;
wherein a one-round scan interval of the second scanning mode is shorter than a one-round scan interval of the first scanning mode.

18. The method of claim 17, further comprising arranging a user interface to receive commands from a user to select the target object from a plurality of detected objects, and to switch from the first scanning mode to the second scanning mode.

19. The method of claim 14, wherein the plurality of first signal parameters comprise at least one: of a number of samples per pulse duration, a number of samples per swath in a pulse repetition interval (PRI), a number of samples per the PRI, a number of PRIs per pulse averaging interval (PAI), a number of PAIs per coherent processing interval (CPI), a minimum detectable range of the first detection distance range, or a maximum detectable range of the first detection distance range.

20. The method of claim 14, further comprising arranging a resource scheduler to derive the plurality of first signal parameters and the plurality of second signal parameters by optimizing a one-round scan interval of the first scanning mode to be shortest while satisfying a plurality of constraints related to the plurality of first signal parameters and the plurality of second signal parameters.
